(19) United States
(12) Patent Application Publication
(10) Pub. No.: US 2025/0140896 A1
(43) Pub. Date: May 1, 2025

(54) PRINTED ADHESIVE FOR HIGH VOLUMETRIC ENERGY DENSITY IN SOLID STATE BATTERIES, AND METHODS OF MAKING AND USING THE SAME

(71) Applicants: Arvind KAMATH, Los Altos, CA (US); Shila ALAVI, San Jose, CA (US); Khanh TRAN, San Jose, CA (US); Mihalis MICHAEL, El Dorado Hills, CA (US); Yasumasa MORITA, San Jose, CA (US)

(72) Inventors: Arvind KAMATH, Los Altos, CA (US); Shila ALAVI, San Jose, CA (US); Khanh TRAN, San Jose, CA (US); Mihalis MICHAEL, El Dorado Hills, CA (US); Yasumasa MORITA, San Jose, CA (US)

(73) Assignee: Ensurge Micropower ASA, Oslo (NO)

(21) Appl. No.: 18/925,267

(22) Filed: Oct. 24, 2024

Related U.S. Application Data
(60) Provisional application No. 63/593,512, filed on Oct. 26, 2023.

(51) Int. Cl. H01M 10/0525; H01M 4/02; H01M 4/485; H01M 4/58; H01M 4/66; H01M 10/0562; H01M 10/0585; H01M 50/11

(52) U.S. Cl. CPC H01M 10/0525; H01M 4/485; H01M 4/5825; H01M 4/661; H01M 4/663; H01M 10/0562; H01M 10/0585; H01M 50/11; H01M 2004/027; H01M 2004/028; H01M 2300/0077

(57) ABSTRACT

A stackable solid-state battery cell, a packaged solid-state battery including the same, and a method of making the same are disclosed. The battery cell includes a substrate, a cathode on or over the substrate, a solid-state electrolyte on the cathode, an anode current collector (ACC) on the solid-state electrolyte, an insulator layer on the ACC having a sidewall portion, a conductive redistribution layer on the insulator layer, including the sidewall portion, in electrical contact with the ACC, and a printed adhesive on a major surface of the cell. The packaged solid-state battery includes a plurality of the stackable solid-state battery cells and battery terminals in electrical contact with an active layer of each cell. The method includes printing the adhesive on the major surface, which can be the outermost surface of the redistribution layer and the insulator layer, or the substrate surface opposite from the cathode.

### CROSS-REFERENCE TO RELATED APPLICATIONS

This application claims the benefit of U.S. Provisional Pat. Appl. No. 63/593,512, filed Oct. 26, 2023, pending, incorporated herein by reference in its entirety.

### FIELD OF THE INVENTION

The present invention generally relates to the field of solid-state and/or thin film batteries. More specifically, embodiments of the present invention pertain to printed adhesives for improving the volumetric energy density in solid-state batteries, and methods of making and using the same.

### DISCUSSION OF THE BACKGROUND

Solid-state lithium batteries are ionic-charge storage devices that are ideally suited for wearable, IoT, and other non-EV applications due to their small size, safety, and high cyclability. To realize a commercially acceptable capacity in a relatively small footprint or area, two or more battery cells may be stacked and connected to the battery terminals in parallel. An adhesive film is used (typically layers of die attach film [DAF]) that comes prepackaged on UV tape (i.e., a plastic tape that can be released from the DAF following irradiation with ultraviolet [UV] light). The DAF on UV tape typically has a thickness of 3-10 μm, and it reduces the volumetric energy density of the battery. The use of UV tape makes it difficult to handle thin substrate devices on the tape.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to solid-state batteries, and more specifically to a solid-state battery having a printed adhesive and methods of making and using the same. The use of a printed adhesive on the battery cells reduces the thickness of the cell (e.g., to a 1-2 μm target thickness) and cost (e.g., by elimination of UV tape and DAF), increases material usage efficiency (e.g., printing avoids unnecessary removal of blanket-deposited material[s]), and forms conformal, void-free layers at or near the uppermost surface of the cells.

Thus, one aspect of the present invention concerns a stackable solid-state battery cell, comprising a substrate, a cathode on or over the substrate, a solid-state electrolyte on the cathode, an anode current collector (ACC) on the solid-state electrolyte, an insulator layer on the ACC and having a sidewall portion, a conductive redistribution layer on the insulator layer, and a printed adhesive on a major surface of the battery cell. The insulator layer is also on a sidewall of each of the ACC, the solid-state electrolyte, the cathode and the substrate, and has an opening enabling electrical contact with the ACC. The redistribution layer is also on the sidewall portion of the insulator layer, and is in electrical contact with the ACC. The major surface of the battery cell may be (i) an outermost surface of the redistribution layer and the insulator layer or (ii) a surface of the substrate opposite from the cathode.

In various embodiments of the stackable solid-state battery cell, the printed adhesive independently has a length and a width that is 80-95% of a length and a width of the battery cell, respectively. In other words, the length of the printed adhesive may be 80-95% of the length the battery cell, and independently, the width of the printed adhesive may be 80-95% of the width of the battery cell.

In other or further embodiments, the printed adhesive may have a thickness of <1 μm. For example, the thickness of the printed adhesive may be in the range of 20-500 nm, or any thickness or range of thicknesses <1 μm (e.g., 50-300 nm).

In various embodiments, the printed adhesive comprises a thermosetting adhesive such as an epoxy adhesive. However, the printed adhesive may comprise another thermosetting or thermoplastic adhesive, such as an (unsaturated) polyester, a polyimide, a phenolic adhesive, a polyamide, a cyanoacrylate, a polyacrylate, a polymethacrylate, a polyvinyl acetate (PVA), or a copolymer thereof. When the adhesive comprises a thermosetting adhesive, the adhesive may further include a curing agent, which may be a heat-activatable curing agent. When the adhesive comprises a radiation-curable adhesive (e.g., an ultraviolet [UV] light-curable adhesive), the adhesive composition may further comprise a UV radiation-activatable curing agent.

In some embodiments, the stackable solid-state battery cell may further comprise a conductive bump on the ACC. The conductive bump may have a height, and the insulator layer having a thickness smaller than the height of the conductive bump.

In various embodiments, the substrate comprises a metal foil, film or sheet. For example, when the substrate comprises the metal foil, and the metal foil may have a thickness of 0.1-100 μm. In other or further embodiments, the substrate may further comprise a barrier on one or more major surfaces of the metal foil, film or sheet. The barrier generally has a thickness effective to prevent migration of atoms or ions from the metal foil into overlying layers, and may comprise a glass or ceramic (e.g., silicon dioxide, aluminum oxide, silicon nitride, and/or a silicon and/or aluminum oxynitride), a metal nitride (e.g., aluminum nitride, titanium nitride, titanium aluminum nitride, tungsten nitride, titanium tungsten nitride and/or tantalum nitride), or an amorphous metal or metal alloy (e.g., a TiW alloy). In embodiments in which the substrate comprises the metal foil, sheet or film, the metal foil, sheet or film may function as a cathode current collector. In such embodiments, at least part of the barrier is a conductive, amorphous material, such as a refractory metal nitride (e.g., as listed above) or an amorphous metal or metal alloy.

In various embodiments, the cathode may comprise a lithium metal oxide or lithium metal phosphate, the solid-state electrolyte may comprise a lithium phosphorus oxynitride, a lithium lanthanum zirconium oxide or Li₂WO₄, and the ACC may comprise nickel, zinc, copper, an alloy thereof, or graphite. In other or further embodiments, the insulator layer may comprise a polyolefin and/or an inorganic oxide (e.g., silicon dioxide, aluminum oxide, silicon nitride, and/or a silicon and/or aluminum oxynitride) layer.

In some embodiments, the stackable solid-state battery cell further comprises a moat in at least the cathode and the solid-state electrolyte, surrounding the ACC and configured to physically separate an active portion of the battery cell from a peripheral region of the battery cell. In further embodiments, the moat may have a width of 3-20 μm, provide an anchoring feature for the insulator layer, fully isolate the active portions of the cathode and electrolyte layers, and/or increase resistance to ingress of (ambient) air and moisture (water vapor).

Another aspect of the present invention relates to a packaged solid-state battery, comprising a plurality of the present stackable solid-state battery cells, a first terminal in electrical contact with the conductive redistribution layer on the sidewall portion of the insulator layer, and a second terminal in electrical contact with an exposed surface of the substrate. At least one adhesive layer of the solid-state battery cells is between adjacent solid-state battery cells.

A further aspect of the present invention relates to a method of making a stackable solid-state battery cell, comprising forming an insulator layer on a patterned anode current collector (ACC), forming a patterned conductive redistribution layer on the insulator layer, and printing an adhesive on a major surface of the battery cell. The ACC is on a solid-state electrolyte, the solid-state electrolyte is on a cathode, and the cathode is on or over a substrate, as discussed for the solid-state battery cell itself. The insulator layer has an opening enabling electrical contact with the ACC, and a portion of the insulator layer is formed on a sidewall of each of the ACC, the solid-state electrolyte, the cathode and the substrate. The patterned redistribution layer is also along the sidewall portion of the insulator layer, such that the redistribution layer is in electrical contact with the ACC. The major surface of the battery cell is (i) an outermost surface of the redistribution layer and the insulator layer, or (ii) a surface of the substrate opposite from the cathode, as discussed for the solid-state battery cell.

In various embodiments of the method, the adhesive has a thickness of <1 μm, as for the solid-state battery cell. Additionally or alternatively, printing the adhesive may comprise screen printing, inkjet printing, stencil printing, gravure printing, or flexographic printing the adhesive in a pattern on the major surface of the battery cell. For example, printing the adhesive may comprise screen printing a solution of the adhesive in a solvent on the major surface of the battery cell, and removing the solvent. The method may further comprise curing the adhesive by heating the adhesive to a curing temperature and/or irradiating the adhesive with ultraviolet light.

In some embodiments, the patterned conductive redistribution layer is selectively deposited on the insulator layer by a process comprising inkjet printing, aerosol-jet printing or screen printing an ink or a paste of a precursor of the conductive redistribution layer, and curing the ink or the paste. In other or further embodiments, the method further comprises blanket-depositing the cathode on or over the substrate, blanket-depositing the solid-state electrolyte on the cathode, and/or forming the patterned ACC on the solid-state electrolyte.

In some embodiments, the method may further comprise printing a conductive bump on the ACC prior to forming the insulator layer. In such embodiments, the opening in the insulator layer is in the same location as the conductive bump, and the conductive bump has a height greater than a thickness of the insulator layer.

In some embodiments, the method may further comprise forming a moat in at least the cathode and the solid-state electrolyte, surrounding the ACC and configured to physically separate an active portion of the battery cell from a peripheral region of the battery cell. The moat may be formed by laser ablation, mechanical dicing, or low-resolution photolithographic patterning (e.g., of a photoresist or other mask material) and etching.

The present invention results in a solid-state battery that has a relatively high volumetric energy density (VED) and relatively low manufacturing cost. Other capabilities and advantages of the present invention will become readily apparent from the detailed description of various embodiments below.

### BRIEF DESCRIPTION OF THE DRAWINGS

FIGS. 1-8 are cross-sectional views of various structures in an exemplary method of manufacturing solid-state battery cells, according to embodiments of the present invention.

FIGS. 9A-B are cross-sectional views of different embodiments of the battery cells of FIG. 8 with a printed adhesive thereon, according to the present invention.

FIG. 10 is a perspective view of an exemplary packaged battery according to one or more embodiments of the present invention.

FIGS. 12-15B show plan (top-down) and cross-sectional views of structures formed in an exemplary method of making solid-state battery cells according to one or more alternative embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present invention concerns a solid-state battery containing a printed adhesive and methods of making and using the same. The present solid-state battery includes, in some embodiments, an intrinsic anode-less battery comprising a substrate (which can also serve or function as a cathode current collector [CCC]), a cathode or cathode layer, a solid-state electrolyte (SSE) or solid-state electrolyte layer, and an anode current collector (ACC). In anode-less embodiments, no lithium anode is formed between the SSE and the ACC during manufacturing. A lithium anode may form during or upon completion of a battery charging operation.

The following discussion provides an example of a manufacturing process for solid-state batteries and stacked solid-state batteries, as well as variations of the process.

### An Exemplary Method of Making a Solid-State Battery

FIGS. 1-8 show certain structures in an exemplary method of making a solid-state battery. FIG. 1 shows a substrate 100, comprising a metal foil, sheet or film 110 and optional first and second barriers 115a-b on opposite major surfaces of the metal foil, sheet or film 110. When the foil, sheet or film 110 is a metal foil, the first and second barriers 115a-b are not optional. The metal foil may comprise or consist essentially of stainless steel, aluminum, copper, nickel, inconel, brass, molybdenum or titanium, the elemental metals of which may be alloyed with up to 10% of one or more other elements to improve one or more physical and/or chemical properties thereof (e.g., oxygen and/or water permeability, flexibility, resistance to corrosion or chemical attack during subsequent processing, etc.). However, the sheet or film can also be a metal sheet or metal roll. For example, the sheet or film may be 0.1-100 μm thick, or any thickness or range of thicknesses therein (e.g., 1-50 μm, 5-30 μm, etc.), whereas a metal sheet may have a thickness of >100 μm, up to about 1-2 mm, although the invention is not so limited. Other alternative substrates include a metal coating on a mechanical substrate, such as aluminum, copper, nickel, titanium, etc., on a removable plastic film, sheet or roll of a relatively flexible material such as an organic polymer (e.g., plastic).

The barrier 115a-b comprises one or more layers of one or more materials in a thickness effective to prevent migration of atoms or ions from the metal foil, sheet or film 110 into overlying layers. The barrier material(s) may comprise a glass or ceramic, such as silicon dioxide, aluminum oxide, silicon nitride, a silicon and/or aluminum oxynitride, etc., a (refractory) metal nitride, such as aluminum nitride, titanium nitride, titanium aluminum nitride, tungsten nitride, titanium tungsten nitride, tantalum nitride, etc., or an amorphous metal or metal alloy, such as a TiW alloy. In some embodiments, each of the first and second barriers 115a-b comprises alternating glass/ceramic and metal nitride layers (e.g., a first metal nitride layer, a first glass/ceramic layer, and a second metal nitride layer, which may further comprise a second glass/ceramic layer, a third metal nitride layer, etc.). Each barrier 115a or 115b, whether a single layer or multiple layers, may have a total thickness of 0.05-3 μm, but the barrier 115 is not limited to this range. The barriers 115a-b may be blanket-deposited onto the foil, sheet or film 110 by chemical or physical vapor deposition (e.g., sputtering, thermal evaporation, atomic layer deposition [ALD], etc.), solution-phase coating with a precursor material followed by annealing to form the glass/ceramic or metal nitride, etc. Exemplary barrier materials, structures and thicknesses and methods for their deposition are disclosed in U.S. Pat. Nos. 9,299,845 and 11,742,363 and U.S. patent application Ser. No. 17/012,010, filed Sep. 3, 2020 (Atty. Docket No. IDR5320), the relevant portions of each of which are incorporated by reference herein.

In some embodiments, the foil, sheet or film 110 functions as a cathode current collector. In such embodiments, at least the barrier 115a (and optionally the barrier 115b) is a conductive, amorphous material, such as the refractory metal nitrides listed above or an amorphous metal or metal alloy (e.g., a TiW alloy).

FIG. 2 shows the metal substrate 100 with a cathode 120 thereon. The cathode 120 may comprise a lithium metal oxide or lithium metal phosphate, such as lithium cobalt oxide (LiCoO₂; LCO), lithium manganese oxide (LiMn₂O₄; LMO), or lithium iron phosphate (LiFePO₄; LFP), for example. The cathode 120 may be blanket deposited by laser deposition (e.g., pulsed laser deposition or PLD), sputtering, chemical vapor deposition (CVD), sol-gel processing, etc. Alternatively, the cathode 120 may be selectively deposited by screen printing, inkjet printing, spray coating, or extrusion coating (e.g., using an ink comprising one or more sol-gel precursors and one or more solvents, having a viscosity appropriate for the printing or coating technique).

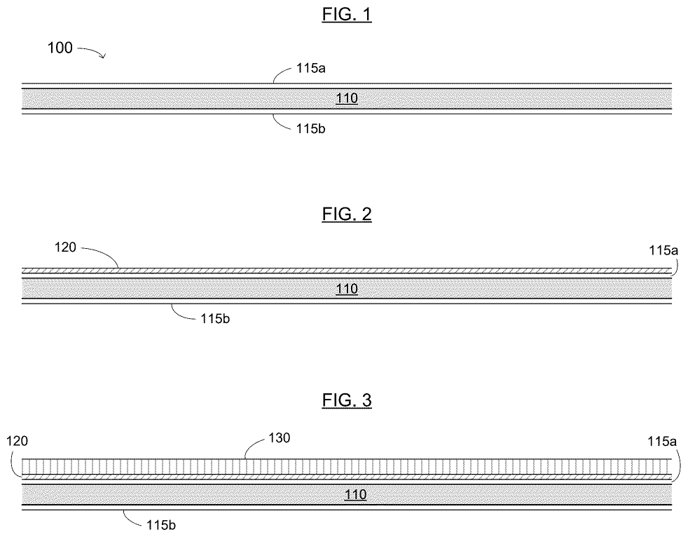

FIG. 3 shows a solid-state electrolyte 130 on the cathode 120. The electrolyte 130 may comprise or consist essentially of a conventional lithium phosphorus oxynitride (LiPON, which may optionally be carbon-doped) or Li₂WO₄, a good Li-ion conductor. Alternatively, the electrolyte 130 may comprise lithium lanthanum zirconium oxide (LLZO). Typically, the electrolyte 130 is a continuous layer or thin film. In some embodiments, the electrolyte 130 may further comprise optional cathode and/or anode interface layers (not shown), each of which may comprise a lithiated metal oxide (see, e.g., U.S. Pat. No. 11,735,791, the relevant portions of which are incorporated herein by reference).

Forming the electrolyte 130 may comprise depositing a LiPON layer or a tungsten oxide layer of the formula WO₃₊ₓ (0≤x≤1) by sputtering, optionally using pulsed DC power. When the electrolyte 130 comprises LiPON, it may be deposited by RF sputtering or ALD. The sputtering target may comprise a Li₃PO₄ or mixed graphite-Li₃PO₄ target, the latter of which may contain 1-15 wt % of graphite, when the electrolyte 130 comprises LiPON or carbon-doped LiPON, and a metallic/elemental tungsten target when the electrolyte 130 comprises a tungsten oxide. In the latter case, sputtering is performed in an oxygen or oxygen-containing atmosphere. The method of making the electrolyte 130 may further comprise lithiating and thermally annealing the WO₃₊ₓ, which can transform it into Li₂WO₄, a good Li-ion conductor. Lithiating may comprise wet lithiation (e.g., immersing the WO₃₊ₓ in a solution containing a lithium electrolyte such as LiClO₄, LiPF₆, LiBF₄, etc., and applying an appropriate electric field) or dry lithiation (e.g., sputtering or thermally evaporating elemental lithium onto the tungsten oxide in a vacuum chamber, optionally while heating the substrate 100). Thermal annealing may comprise heating at a temperature of 150-500° C. for a length of time of 5-240 minutes, or any temperature or length of time therein (e.g., 250-450° C. for 10-120 minutes), in a conventional oven, a vacuum oven, or a furnace. To ensure substantially complete diffusion of the lithium into and/or throughout the WO₃₊ₓ, the WO₃₊ₓ should be annealed (preferably in air) at a temperature of at least 100° C. for at least 10 minutes (e.g., to transform it into Li₂WO₄).

FIG. 4 shows a number of anode current collectors (ACCs) 140a-d in a pattern on the electrolyte 130, thus forming substantially complete (but unsealed) cells. A separately-formed anode is not necessary in solid-state lithium batteries, as a lithium anode can be formed between the electrolyte 130 and the anode current collectors 140a-d during charging, if necessary. Optionally, however, a thin lithium anode can be deposited by evaporation onto the electrolyte 130 prior to formation of the anode current collectors 140a-d. In such a case, the lithium anode and the ACCs 140a-d should be deposited in a dry, inert atmosphere (which may have a reduced pressure, such as 0.01-100 mTorr).

The anode current collectors 140a-d generally comprise a conductive metal, such as nickel, zinc, copper, alloys thereof (e.g., NiV), etc., or another conductor, such as graphite. The anode current collectors 140a-d can be selectively deposited by screen printing, inkjet printing, spray coating, etc. Typically, the printed anode current collectors 140a-d are cured by irradiating with ultraviolet (UV) light, heating (e.g., up to a temperature of about 550° C., but more commonly, up to about 400° C.), or a combination thereof. Alternatively, the anode current collectors 140a-d may be formed by blanket deposition (e.g., sputtering or evaporation) and patterning (e.g., low-resolution photolithography, development and etching). The anode current collectors 140a-d may have a thickness of 0.1-5 μm, although it is not limited to this range.

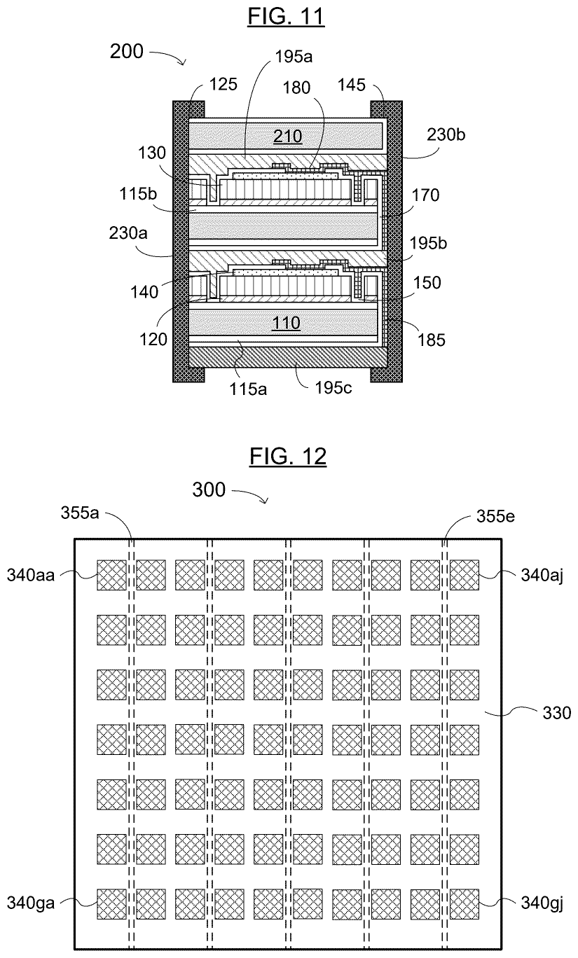

The anode current collectors 140a-d may have area dimensions (i.e., length and width dimensions) that are 50-95% of the corresponding length and width dimensions, respectively, of the cell (see e.g., FIGS. 8 and 12), although the borders of the anode current collectors 140a-d may be offset (pulled back) a relatively small or minimal distance from the ultimate cell borders, in some embodiments. The pull-back distance of the ACCs 140a-d from the cell edges should be sufficient to electrically isolate the ACCs 140a-d from the CCC/substrate 100.

The cells may further include one or more interlayers that modify the interfaces between layers. For example, a metal oxide (e.g., Nb₂O₅, Al₂O₃, Li₄Ti₅O₁₂ or LiNbO₃) interlayer may be formed on the cathode 120 prior to deposition of the electrolyte 130 (e.g., to reduce interfacial stress, decrease interfacial resistance, or suppress formation of a space charge layer). An amorphous (e.g., elemental silicon) interlayer may be deposited on the electrolyte 130 prior to formation of the anode current collectors 140a-d to inhibit reduction of the electrolyte. Of course, the battery cell can be made in the reverse order (i.e., the anode current collector may be first formed on the substrate, then the remaining layers deposited in reverse order thereon).

An advantage of the present method is that some/all of the active battery layers (e.g., the cathode 120 and the solid-state electrolyte 130) are deposited as blanket layers. This maximizes the active area utilization of the battery cells for high intrinsic capacity, and also results in a topographically planar or “flat” cell to facilitate formation of the uppermost layer(s) and downstream packaging due to the pattern-free blanket-deposited layers. However, if necessary or desired, the cathode 120 and the SSE 130 can be slightly pulled back from the cell edge by subtractive patterning (e.g., low-resolution photolithography, laser ablation) or selective deposition (as described herein).

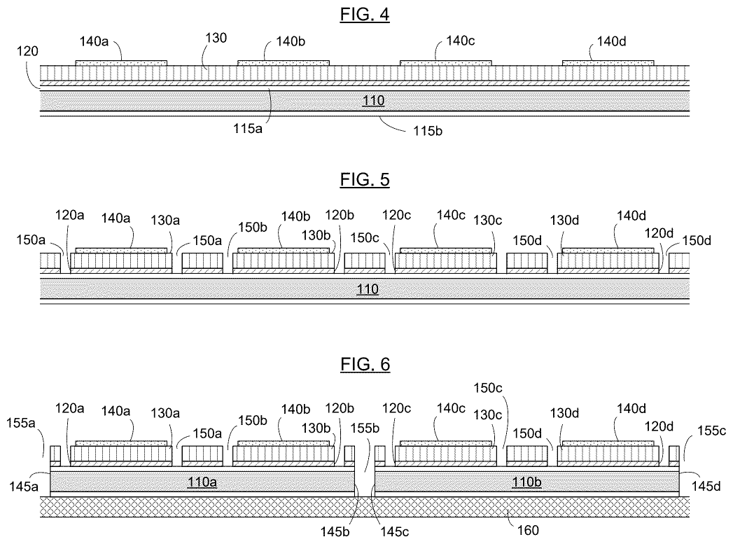

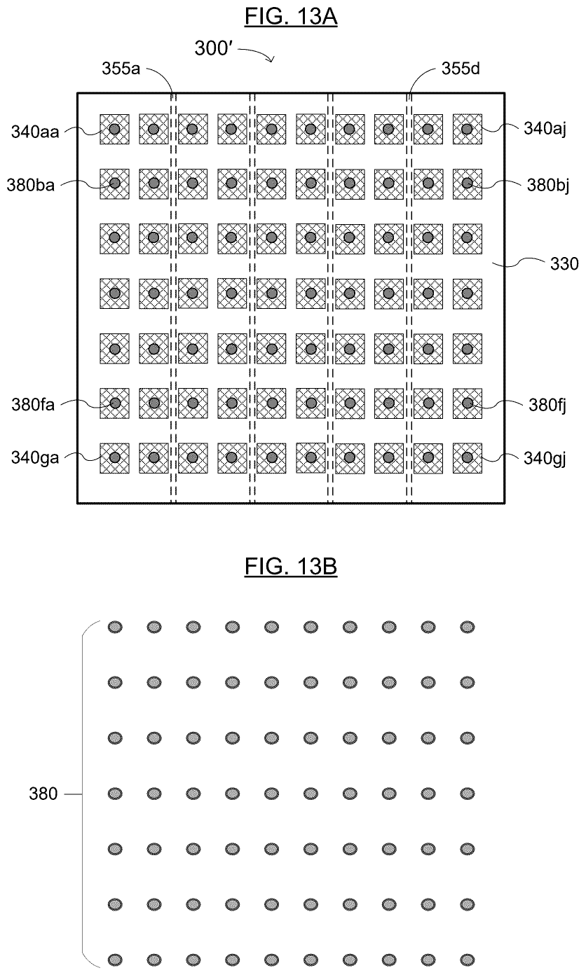

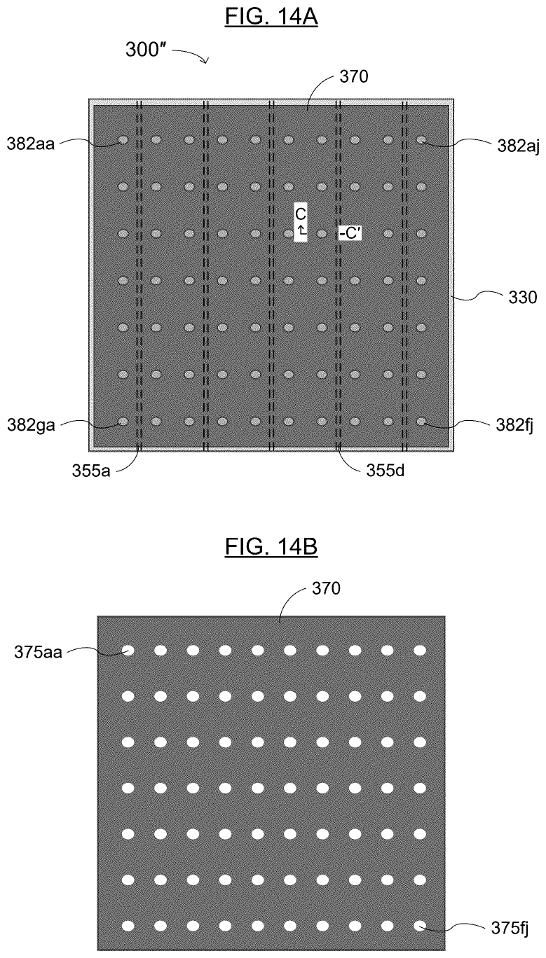

FIGS. 5-8 show intermediate structures in a process for moat formation, ACC-edge electrical isolation and cell encapsulation, followed by formation of an interconnect/via and redistribution layer for contact with the anode current collector 140. FIG. 5 in particular shows formation of moats 150a-d. In the present invention, however, the moats 150a-d and their formation are optional (see, e.g., FIGS. 12-13).

After cell fabrication as described above, FIG. 5 shows the devices receiving a shallow cut through both of the cathode 120 and the solid-state electrolyte 130 (and optionally slightly into the substrate 100) outside of the ACCs 140a-d to form moats 150a-d that completely surround the respective ACCs 140a-d. When the ACCs 140a-d extend into the area or region where the moats 150a-d are formed, moat formation removes the peripheral portions of the ACCs 140a-d that extend into the area or region of the moats 150a-d. In the present invention, however, the moats 150a-d and their formation are optional.

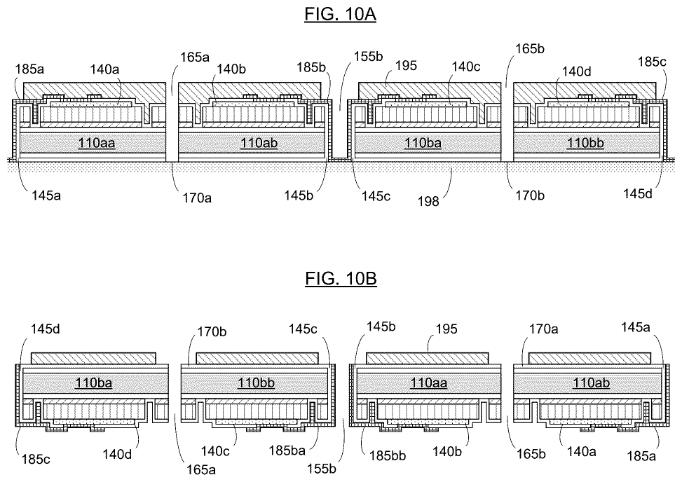

The moats 150a-d may be formed by laser ablation, mechanical dicing, or low-resolution photolithographic patterning (e.g., of a photoresist or other mask material) and etching. The moats 150a-d may have a width of 3-20 μm, although the invention is not limited to such widths. The moats 150a-d provide an anchoring feature for cell encapsulation (see the discussion below with regard to FIG. 7) and physically separate the active portion(s) of the battery layers from a peripheral dummy region. When the moats 150a-d extend into the substrate 100, they fully isolate the active cathode and electrolyte layers 120 and 130. Each of these aspects of the moats 150a-d increases resistance to ambient ingress.

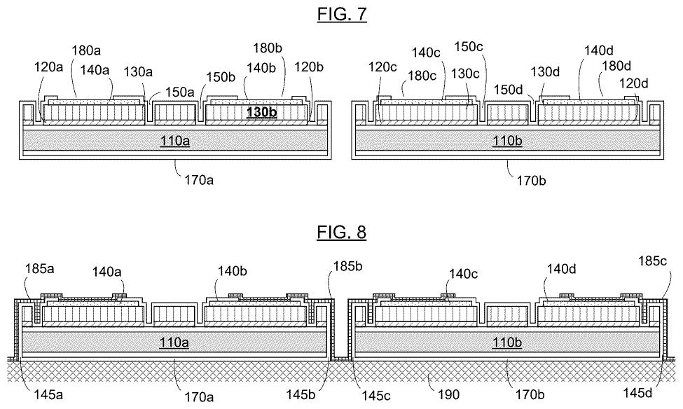

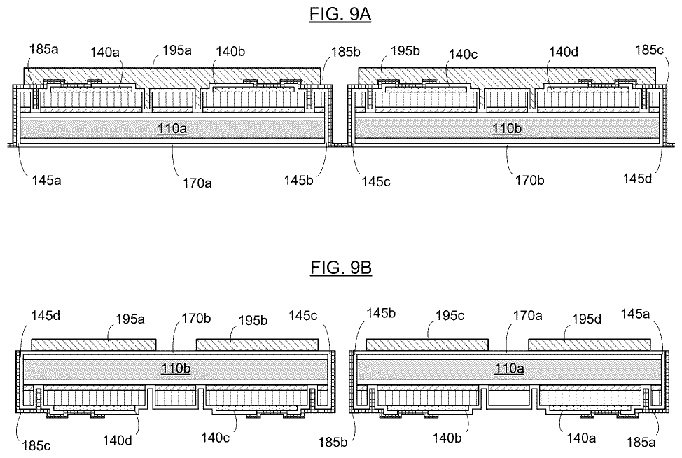

Referring to FIG. 6, the substrate 100 is on or attached to a substrate support 160 (e.g., a removable tape or sheet), and the electrolyte 130, the cathode 120 and the substrate 100 are cut or diced along the “ACC edges” 145a-d of the battery cells to form an opening 155a-c every other cell, or every other row or column of cells (when the cells are in an array or on a multi-column, multi-row roll). This step is also optional in the present method. When the substrate support 160 is a tape or sheet, the tape or sheet 160 is generally a UV release tape or sheet, containing an adhesive on one or both major surfaces that loses its adhesive properties upon sufficient irradiation with ultraviolet (UV) light. The tape or sheet 160 may be on a ring or other frame, configured to mechanically support the tape or sheet 160 and allow some tension therein and some light to pass through the underside of the tape or sheet. When the substrate support 160 is substrate holder (e.g., for cutting or dicing by stamping), it may comprise a magnetic plate or chuck. Exemplary mechanical dicing and stamping processes are disclosed in U.S. patent application Ser. No. 18/885,525, filed Sep. 13, 2024 (Atty. Docket No. IDR2022-06), the relevant portions of which are incorporated herein by reference.

The ACC cell edges 145a-d are cut by laser (e.g., laser ablation), mechanical dicing or stamping, for example. When the cells are in an array or on a multi-column roll, they may also be cut or diced along the x-direction in FIG. 6 between adjacent cells (e.g., every column, or every row; see, e.g., FIG. 12) to form isolated cell pairs. The cuts along the x-direction may be made in the same process or a different process. For example, when the cuts are made by laser, the cuts in the z-direction (as shown in FIG. 6) and in the x-direction may be made in the same process (e.g., a continuous dicing process), and when the cuts are made by mechanical dicing or stamping, the cuts in the x-direction are typically made in a separate process from those made in the z-direction. (The z-direction in FIG. 6 is the y-direction in FIG. 12.) The sidewalls 145a-d along the cuts fully expose the entire cell stack, including the CCC/substrate 110. In a further option, the electrolyte 130, the cathode 120 and the substrate 100 between adjacent moats 150 not containing an ACC 140 are cut or diced (see, e.g., FIG. 9, which shows the further cuts resulting in “CCC edges” 125).

Referring now to FIG. 7, after the diced cell pairs are released from the tape or sheet 160, the cell pairs are substantially encapsulated with a mechanically compliant moisture barrier and electrical insulation film 170a-b. The barrier/insulation film 170a-b also lines the inner surfaces of the moats 150a-d to provide further electrical isolation and moisture barriers to protect the battery cells. The barrier/insulation film 170a-b may cover the front or uppermost surface of the cells, the “ACC” side surface 145a-d of the cells and optionally, the backside surface of the cells. The barrier/insulation film 170a-b may be printed (e.g., by inkjet printing or screen printing) onto the cells.

The barrier/insulation film 170a-b may comprise parylene, polyethylene, polypropylene, or another polyolefin, with or without a thin (and optionally printable) inorganic oxide overlayer such as SiO2 (e.g., formed by heating a tetraalkyl silicate such as tetraethyl orthosilicate [TEOS]). The material(s) of the barrier/insulation film 170a-b may be dissolved or suspended in an appropriate solvent (e.g., an organic solvent, as described elsewhere herein) prior to printing. In certain embodiments, after printing, the material for the barrier/insulation film 170a-b may be cured (e.g., by irradiation with ultraviolet light) to provide certain desirable properties (e.g., hardness, optical properties, adhesion, etc.).

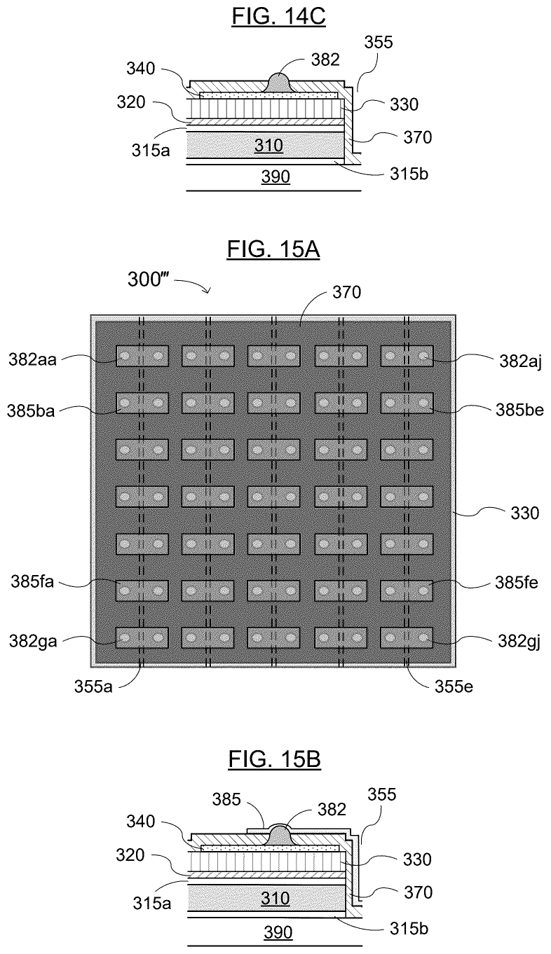

One advantage of printing to form the barrier/insulation film 170a-b is that an opening 180a-d may be formed on each cell over the ACC 140 during printing (see, e.g., FIG. 14B, which show similar or identical openings 375aa-fj), without any need for additional processing (such as laser ablation, photolithographic patterning, etc.) to form the openings. Another advantage of printing is that, if further cuts resulting in “CCC edges” 125 are made, such edges can be selectively not covered with the barrier/insulation film 170a-b by simply not printing the barrier/insulation film 170a-b on those edges.

FIG. 8 shows formation of redistribution metal layers 185a-c in a pattern along the ACC edges 145a-d and in vias or openings 180a-d in the barrier/insulation films 170a-b to connect the ACCs 140a-d to a subsequently formed external battery terminal (e.g., an anode). In the embodiment(s) shown in FIG. 8, the redistribution metal layers 185a-c make direct and/or ohmic contact with the ACCs 140a-d. In some embodiments, the battery cells may be transferred to a support 190 (e.g., a tape [for example in a roll] or a vacuum or electrostatic chuck) prior to forming the redistribution metal layers 185a-c. The redistribution layers 185a-c may comprise Cu, Ni, Al, or another suitable and/or stable (e.g., air- and/or water-stable, and/or lithium-compatible) metal, and may be formed by sputtering, ALD or thermal evaporation (e.g., through a mask that exposes a region of the cell corresponding to the pattern of the redistribution layers 185a-c, followed by removal of the mask, or by blanket deposition, followed by photolithographic patterning and etching), or by selective deposition, such as inkjet printing, aerosol-jet printing or screen printing. Printing may comprise use of a conventional metal-containing ink or paste. To facilitate deposition or printing of the redistribution layers 185a-c, the battery cell pairs or strips of battery cell pairs may be placed on a holder, such as a magnetic plate, chuck or other substrate carrier.

Low electrical resistance and a low curing temperature are desirable for the redistribution layers 185a-c, and the redistribution layers 185a-c have a thickness typically in the range 0.25-2 μm on the uppermost surface of the cells. For example, regardless of how the redistribution layers 185a-c are deposited, the redistribution layers 185a-c may be cured (e.g., by heating or sintering, optionally after drying in the case of printing an ink or paste) at a temperature of 150-550° C., or any temperature or range of temperatures therein (e.g., 150-350° C.), for a length of time sufficient to convert the deposited material to a conductive metal. Due to liquid flow, the entireties of the vias or openings 180a-d may be filled with metal, which may be beneficial during battery cycling. When the moats 150 are present, deposition of the redistribution layers 185a-c by printing, sputtering, or thermal evaporation may also fill the portions of the moats 150 nearest to the ACC edges 145a-d with metal, facilitating the ingress-barrier function of the moat 150 along the ACC edge 145.

A single redistribution layer (e.g., 185b) is on the ACC edges 145a-d of adjacent cells. The redistribution layers (or ACC redistribution traces) 185a-c go from the ACCs 140a-d exposed through the vias or openings 180a-d to the ACC edges 145a-d, in the opposite direction from the CCC edges 125 (FIGS. 10A-B), and across the openings 155a-c. In a plan view (e.g., FIG. 15), the redistribution layers 185a-c may be formed or deposited individually across a cell pair (see redistribution layers 385aa-ge in FIG. 15), or alternatively, along an entire column of cell pairs (e.g., in a strip).

The ACC redistribution traces 185a-c electrically contact the ACCs 140a-d through the vias 180a-d, but are physically and electrically insulated from the CCCs/substrates 110a-b by the barrier/insulation films 170a-b. When the ACC redistribution traces 185a-c are a metal, they form an intrinsic barrier to ambient ingress in the region of the vias or openings 180a-d. The ACC redistribution traces 185a-c are both physically on the top surface of the cell and covering at least part of the corresponding sidewalls 145a-d. The ACC redistribution traces 185a-c on the sidewalls 145a-d enable electrical connection to the cells through a terminal on the side of the battery at a later stage of the method.

In some embodiments, the method comprises printing both the insulator for the barrier/insulation film 170a-b and the metal (e.g., the ACC redistribution traces 185a-c, and optionally, the ACCs 140a-d), using dual (separate) inkjet printer heads. Preferably, the materials for the barrier/insulation film 170a-b and the ACC redistribution traces 185a-c are printed separately, with an optional curing step between the separate printing steps, if necessary or desired, although they may be printed simultaneously in some cases (e.g., where the solvents for the different layers are immiscible). This allows for faster cycle times and more efficient use of capital for manufacturing equipment.

FIG. 9A shows battery cell pairs or strips of battery cell pairs with an adhesive 195a-b printed on the uppermost surface, and FIG. 9B shows battery cell pairs or strips of battery cell pairs with an adhesive 195a-d printed on the “non-functional” surface of the substrates 110a-b. “Non-functional” refers to the lack of functional battery structures or layers on the underside of the substrates 110a-b, as shown in FIGS. 2-8. The printed adhesive, after drying and curing, may have a thickness of <1 μm (e.g., 20-500 nm, or any thickness or range of thicknesses therein),

In both cases (FIG. 9A and FIG. 9B), the adhesive is preferably a thermosetting adhesive such as epoxy adhesives, but other thermosetting and thermoplastic adhesives, such as (unsaturated) polyesters, polyimides, phenolic adhesives, polyamides, cyanoacrylates, polyacrylates, polymethacrylates, polyvinyl acetate (PVA) and copolymers thereof may also be suitable. If the uncured adhesive has a viscosity that is undesirably high for the printing technique and/or target thickness of the adhesive 195, an amount of an organic solvent (e.g., an alkane, cycloalkane, arene, alkyl arene, ether, cyclic ether, or haloalkane solvent having a boiling point of about 150° C. or less) sufficient to adjust the viscosity for the printing technique and/or target thickness may be added. Typically, the adhesive is screen printed onto the battery cell surface, but other printing techniques, such as inkjetting, stencil printing, gravure printing, or flexographic printing can also be used. When the adhesive is a thermosetting adhesive, the composition to be printed may further include a curing agent (which may be activated by heat, for example a temperature of 80-200° C.). When the adhesive is a radiation-curable adhesive (e.g., an adhesive that is cured by irradiation with ultraviolet [UV] light), there should be a path for the radiation (e.g., light) to reach the adhesive.

The adhesive, when in a pre-cured or partially cured state, can flow into any depressions in or above the ACC redistribution traces 185a-c in the vias or openings 180a-d, as well as any openings in the moats 150a-d. Eliminating voids or trapped gasses in such depressions and in the moats 150a-d can provide benefits during cycling (e.g., preservation of electrical contact with the ACCs 140a-d).

In some embodiments, it may be beneficial to avoid printing the adhesive onto the redistribution layer 185 along the ACC edge 145 of a cell. This avoids any need to remove some of the adhesive prior to forming the contact with the redistribution layer 185 along the ACC edge 145. The adhesive can be printed over the cell pairs to fill the moats 150 and any depression over the openings 180 to the ACCs 140, but not so close to the edges of the cell pairs that adhesive is on the redistribution layer 185 along the sidewall 145 of the cells.

Bottom-side printing of the adhesive is shown in FIG. 9B. In such embodiments, the adhesive can flow into vias in an underlying cell during stacking (FIG. 10). FIG. 9B shows an example in which adhesive is printed only in the area of the cells, which can also be done in top-side printing (FIG. 9A), but it may be more challenging to ensure that the adhesive flows into the moats 150 when the adhesive 195 is printed only in the area of the cells during top-side printing. In FIG. 9B, the redistribution layer 185b between cell pairs (i.e., between ACC edges 145b and 145c) is severed, which can also happen in top-side printing (FIG. 9A). However, an advantage of top-side printing is that the same holder can be used for printing the encapsulation 170, the redistribution layer 185, and the adhesive 195a-b, in which case the redistribution layer 185b may not necessarily be severed in FIG. 9A.

In either top-side or bottom-side adhesive printing, the printed adhesive may have a length and/or a width that is 80-95% of the length and/or width of the die/cell, respectively, leaving 5-20% of the die along two or more edges uncovered. Such embodiments can avoid having to cut uncured or partially-cured adhesive during singulation, thereby minimizing cleaning and/or maintenance of the singulation equipment. However, such embodiments still provide sufficient coverage of the die/cell for the adhesion function and the air/water ingress prevention function to work.

FIGS. 10A-B show singulated battery cells or single battery cell strips on substrates 110aa, 110ab, 110ba and 110bb. Prior to singulation (dicing), the cell pairs or cell pair strips of FIGS. 9A-B may be placed on a carrier 198 (FIG. 10A). Dicing along the CCC edges 125 (to form openings 165a and 165b) creates the single cells. Alternatively, dicing along the CCC edges 125 can be performed at the same time as dicing along the ACC edges 145 (FIG. 6). The adhesive 195 holds the cells together during stacking (FIG. 11), and may provide a passivation/sealing layer on one or more sides or surfaces of the stacked cells during packaging. Singulation may be conducted by stamping, mechanical dicing (e.g., sawing), or laser dicing. The adhesive 195 may also be cut during singulation (FIG. 10A). The redistribution layer 185b (FIG. 8) may be cut or separated to form redistribution layers 185ba and 185bb either during singulation or during removal (e.g., from a chuck or other holder) at or near the end of the redistribution layer formation process.

As shown in FIG. 11, stacking forms a multi-layer set of parallel cells 200 with the CCC (substrate) edges 125 along one side of the stack, and the ACC edges 145a-d (including the ACC trace/redistribution layers 185) along the opposite side. The printed adhesion layer 195b between cells form an airtight seal between the cells, and effectively prevents ingress of air and water vapor. The printed adhesion layer 195a between the top cell and a dummy substrate or cell 210 provides the same functions in that space. After stacking, but prior to formation of the battery terminals 230a-b, an outer adhesive layer 195c may be printed on the underside of the stacked cells 200 for a similar purpose. To further protect the stacked cells 200, a paper, plastic or similar protective material may be placed on the outer surface of the adhesive layer 195c. Alternatively, a polymeric or dielectric coating may be substituted for the adhesive layer 195c. In some embodiments (e.g., in which the insulation film 170 has a sufficient thickness), the adhesive layer 195c can be omitted. The stacked set of cells 200 forms a stacked solid-state battery. The parallel cells each additively contribute to the overall battery capacity.

Cell stacking may comprise a conventional pick-and-place technique. However, other stacking methods, such as strip folding, strip stacking, etc. (see, e.g., U.S. patent application Ser. No. 17/185,122, filed Feb. 25, 2021 [Attorney Docket No. IDR2020-02], and U.S. Provisional Pat. Appl. No. 63/598,912, filed Nov. 14, 2023 [Attorney Docket No. IDR2022-10-PR], the relevant portions of each of which are incorporated herein by reference), before or after dicing are also acceptable. A dummy cell 210 (e.g., an encapsulated metal foil substrate, for example as described with respect to FIGS. 1 and 7) may be placed on top of the stack 200 as a moisture and air barrier and to protect the stack 200 from externally-caused damage. Optionally, markings on one major surface of the dummy cell 210 can be used as external product markings.

Battery terminal dipping and plating the stacked set of cells 200 forms external electrical contacts 230a-b, as shown in FIG. 11. End terminals at the CCC and ACC edges 125 and 145 (e.g., the exposed edges of the CCCs 110 and the redistribution layers 185, respectively) are dipped into or coated with a conductive epoxy to electrically gang the terminals and form the CCC terminal 230a and ACC terminal 230b of the packaged battery. The conductive epoxy may comprise an Ag-filled or Ni-filled conductive epoxy paste. Alternatively, a pin-to-pin paste transfer method may be used, or a stable and/or noble metal such as Au, Pt, Pd or Cu can be used in place of the Ag or Ni. Plating a metal onto part or all of the CCC terminal 230a and ACC terminal 230b creates a solderable surface for PCB attachment by the end user. For solderable termination, the epoxy surface may be plated with Ni, Ag, In, Sn, or a combination thereof (e.g., Ni, then with In or Sn).

In some embodiments, the conductive epoxy 230a-b contains a relatively high metal content, which can retard ambient ingress (e.g., of oxygen or water vapor). The epoxy 230a-b may be plated with one or more pure metal layers, to further block ambient ingress. Both of these features help with ambient air and moisture resistance, particularly on the CCC edge 125, due to the barrier/insulation film 170 being unapplied (or diced) at this edge during cell or cell strip singulation from the cell or cell strip pairs (FIG. 9).

Structures formed during an alternative process for printing the barrier and/or passivation layer and a conductive adhesive (e.g., in the openings in the barrier and/or passivation layer) on an array of solid-state battery cells is shown in FIGS. 12-15B. The array is generally on the metal foil substrate, and the metal foil substrate may be in the form of a sheet or roll of the metal foil.

FIG. 12, for example, shows a plan (top-down) view of an array 300 of battery cells on a support (not identified). The battery cells include an uppermost pattern of ACCs 340aa-340gj, substantially as described herein with reference to ACCs 140a-d (FIG. 6). The ACCs 340aa-340gj may be printed or otherwise formed on the solid-state electrolyte layer 330, substantially as described for the ACCs 140a-d (FIG. 4) and the electrolyte 130 (FIG. 3). Openings 355a-e (FIG. 12) penetrating the solid-state electrolyte layer 230 and the underlying cathode and substrate (not shown), and exposing the support are shown in outline (dashed line) form, and are substantially as described herein with reference to openings 155a-c (FIG. 6). The support may be similar, substantially identical or identical to the tape, sheet or substrate holder 160 (FIG. 6) or the tape or the vacuum or electrostatic chuck 190 (FIG. 8) discussed above. However, a moat may or may not be formed in the alternative process. In the exemplary structures shown in FIGS. 12-15B, a moat is not formed.

FIG. 13A shows the array 300′ of battery cells from FIG. 12 with a conductive paste 380aa-380gj on the ACCs 340aa-340gj. The conductive paste 380aa-380gj functions as a type of via or contact between the ACCs 340aa-340gj and an overlying redistribution trace to be formed later. The conductive paste 380aa-380gj may be printed on the ACCs 240aa-240gj by any of a variety of printing techniques (e.g., screen printing, inkjet printing, stencil printing, gravure printing, flexographic printing, etc.). The conductive paste 280aa-280gj may be cured (e.g., by heating or sintering) at a temperature of 150-400° C., or any temperature or range of temperatures therein (e.g., 150-300° C.), for a length of time sufficient to substantially convert the paste to the conductive bumps. Alternatively, curing may comprise irradiating with UV light, or a combination of irradiating with UV light and heating, as described herein. A method of printing a conductive paste or resin to form such conductive bumps is disclosed in U.S. patent application Ser. No. 15/750,481 (Atty. Docket No. IDR4470), filed Feb. 5, 2018 and entitled “Wireless Tags With Printed Stud Bumps, and Methods of Making and Using the Same,” the relevant portions of which are incorporated herein by reference.

The conductive paste 380aa-380gj may comprise an electrical conductor (e.g., filaments, flakes or a powder of a metal such as silver, nickel or copper, or of another electrically conductive material such as graphite) in a liquid or otherwise flowable medium. The liquid/flowable medium may comprise a varnish, a synthetic and/or adhesive resin such as an epoxy resin, a (meth)acrylate resin, a poly(alkylene oxide), ethyl cellulose or hydroxyethyl cellulose, or an adhesive silicone polymer, optionally in one or more organic solvents such as methanol, ethanol, isopropanol, 1-methoxypropan-2-ol, 1-ethoxypropan-2-ol, 1-methoxy-propan-3-ol, 1-ethoxypropan-3-ol, acetone, methyl ethyl ketone, methyl acetate, ethyl acetate, diethyl ether, methyl t-butyl ether, etc. Alternatively or additionally, the conductive paste may include a synthetic resin such as cellulose or a thixotropic agent such as castor oil, hydrogenated castor oil, an amide-modified castor oil derivative, a fatty amide, etc. In some embodiments, the conductive paste 380aa-380gj is a conductive adhesive paste or a solder. The solder generally comprises an alloy of tin and one or more alloying elements selected from bismuth, silver, copper, zinc, and indium. In other or further embodiments, the conductive paste 380aa-380gj is cured prior to the next step, thereby forming conductive bumps 382aa-382gj (FIG. 14A). A pattern 380 of the conductive paste is shown in FIG. 13B.

The bumps formed from the conductive paste 380aa-380gj may have a thickness of 0.1 to 50 μm (e.g., 0.3-10 μm or any value or range of values therein) and a diameter of 20 to 2000 μm (e.g., 50-1500 μm or any value or range of values therein) at half of the height (or thickness) of the bumps. The conductive bumps 380aa-380gj may have a radius at the base of 30 to 3000 μm (e.g., 60-2000 μm or any value or range of values therein). For example, when screen printed, the conductive bumps 380aa-380gj can be formed when the screen has holes or openings with a radius of 20 to 2000 μm (e.g., 50-1500 μm or any value or range of values therein).

FIG. 14A shows the array 300″ of battery cells from FIG. 13A with an insulator layer 370 on the ACCs 340aa-340gj and the electrolyte layer 330, as well as in the openings 355a-e and on the support exposed in the openings 355a-e. The insulator layer 370 may also be deposited into any moats in the active battery layers, if present (see, e.g., FIG. 7). The insulator layer 270 may comprise or consist essentially of the same materials discussed herein for insulator layer 170 (FIG. 7). The conductive bumps 382aa-382gj, which may be cured, partially cured or uncured, remain exposed through openings in the insulator layer 370.

As shown in FIG. 14B, the insulator layer 370 is selectively deposited in a pattern that includes openings 375aa-375fj that correspond or substantially correspond to the conductive paste pattern 380 shown in FIG. 13B. In other words, the openings 375aa-375fj are in the same locations as the conductive bumps 382aa-382gj. A precursor material for the insulator layer 370 may be selectively deposited by any of the printing techniques described herein, but inkjet printing or aerosol-jet printing (e.g., using a sol-gel precursor solution as described herein), or screen printing (e.g., using a suspension of fine particles of an electrically insulating material such as silica, alumina, zirconia, titania, mixtures or combinations thereof, etc., in an organic solvent, optionally with a conventional binder), are particularly suitable. After printing, the precursor material may be conventionally cured to form the insulator layer 370. For example, the precursor material may be cured (e.g., by heating or sintering) at a temperature of 50-350° C., or any temperature or range of temperatures therein for a length of time sufficient to substantially convert the precursor material to the insulator.

In some embodiments, the openings 375aa-375fj in the insulator layer 370 have an area or diameter slightly larger than that of the conductive bumps 382aa-382gj. For example, the openings 375aa-375fj may have an area that is 1-50% larger than that of the conductive bumps 382aa-382gj, or a radius or diameter that is 1-20% larger than that of the conductive bumps 382aa-382gj.

FIG. 14C shows a cross-section of a single cell across the line C-C′ in FIG. 14A, including conductive bump 382 on the ACC 340, with the insulator layer 370 surrounding the conductive bump 382 and covering the ACC 340, the other battery cell layers (i.e., electrolyte 330 and cathode 320), and the barrier 315a on the substrate 310. The insulator layer 370 is on the battery cell sidewall in the opening 355. As shown in FIG. 14C, the conductive bump 382 has a bell-shaped cross-sectional profile, but other profiles, such as hemispherical, substantially hemispherical, cylindrical, square, rectangular (optionally with rounded corners), etc., are suitable. The cross-section in FIG. 14C is not drawn to scale, and the conductive bump 382 may have an aspect ratio (height-to-width or height-to-diameter ratio) that is <1:1, ≤2:1, ≤5:1, or any other value or range of values <1:1 (e.g., from 1:10 to 1:100).

The insulator layer 370 has a thickness less than that of the conductive bump 382. Ideally, the thickness of the insulator layer 370 is 40-80% of the thickness of the conductive bump 382. The greater the mass loading of the insulating material or insulator precursor in the material printed for the insulator layer 370, the closer that the thickness of the insulator layer 370 can be to the thickness of the conductive bump 382, as the thickness of the printed material for the insulator layer 370 (e.g., including solvent, binder, etc.) should also be less than the thickness of the conductive bump 382 to avoid the possibility of insulator material remaining on the entire uppermost surface of the conductive bump 382. In addition, the closer the thickness of the insulator layer 370 is to 100% of the thickness of the conductive bump 382, the less surface area of the conductive bump 382 is available for ohmic contact to an overlying conductor (e.g., a redistribution layer 385; see FIG. 15B). However, to ensure electrical isolation of the active battery layers along the ACC edge of the die, the insulator layer 370 should have a minimum thickness (which depends on many factors, such as the chemical identity of the insulator layer 370, the manner in which it is applied, the technique by which the die are diced, the materials of the substrate 310, the barriers 315a-b, the ACC 340, etc.).

FIG. 15A shows the array 300″ of battery cells from FIG. 14A with a redistribution metal layer 385aa-385ge on the insulator layer 370 and the conductive bumps 382aa-382gj, as well as in the openings 355a-e. The redistribution metal layer 385aa-385ge is similar or substantially similar to the redistribution metal layer 185 described above with respect to FIG. 8, but electrically contacts the ACCs 340aa-gj through the conductive bumps 382aa-382gj.

The redistribution metal layer 385aa-385ge may be formed by selective deposition, such as thermal evaporation (e.g., through a mask that exposes regions of the cells corresponding to the pattern of the redistribution layers 385aa-ge, followed by removal of the mask), inkjet printing, aerosol-jet printing or screen printing. When printed, the redistribution layers 385aa-ge may be deposited as a metal precursor in an ink or paste. The paste may be as described herein, and the ink may comprise a metal salt, compound or complex in one or more solvents such as water, an alcohol, a cyclic or acyclic ether or polyether (e.g., dimethoxyethane, diglyme), an alkoxysilane, a cyclic or acyclic ketone, a cyclic or acyclic ester, an amide (e.g., dimethyl formamide), a dialkyl sulfoxide (e.g., dimethyl sulfoxide), etc., and one or more optional additives (e.g., a mineral acid). Examples of such inks are disclosed in U.S. Pat. No. 8,066,805, the relevant portions of which are incorporated herein by reference. The redistribution layers 385aa-ge may be cured as described above for redistribution layer 185.

FIG. 15B shows a cross-section of a single cell in FIG. 15A, across the same line as line C-C′ in FIG. 14A, including redistribution layer 385 on (and in physical and/or ohmic contact with) the conductive bump 382 and along the sidewall of the insulator layer 370. As shown in FIG. 15B, there may be some thinning of the redistribution layer 385 at the apex of the conductive bump 382.

Following formation of the redistribution metal layer 385aa-385ge, an adhesive is printed on the battery cells as discussed with respect to FIGS. 9A-B, and the individual cells are singulated as discussed with respect to FIGS. 10A-B. The combined redistribution layer 385 and insulator layer 370 are relatively easily broken when separated from the support/carrier 390 (FIGS. 14C and 15B). The individual cells may be stacked and packaged as discussed with respect to FIG. 11.

### CONCLUSION

The invention provides solid-state battery cells with an adhesive having a reduced thickness, compared to relatively fragile, expensive and material-consuming DAF films. This substantially increases the volumetric energy density of the unit cell. Expensive UV tape is eliminated, and material costs are substantially reduced due to printing (lower material utilization, no wastage of DAF) and cheaper materials.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A stackable solid-state battery cell, comprising:
a substrate;
a cathode on or over the substrate;
a solid-state electrolyte on the cathode;
an anode current collector (ACC) on the solid-state electrolyte;
an insulator layer on the ACC and having a sidewall portion on a sidewall of each of the ACC, the solid-state electrolyte, the cathode and the substrate, wherein the insulator layer has an opening enabling electrical contact with the ACC;
a conductive redistribution layer on the insulator layer, including the sidewall portion thereof, and in electrical contact with the ACC; and
a printed adhesive on a major surface of the battery cell.

2. The stackable solid-state battery cell of claim 1, wherein the major surface is (i) an outermost surface of the redistribution layer and the insulator layer or (ii) a surface of the substrate opposite from the cathode.

3. The stackable solid-state battery cell of claim 1, wherein the printed adhesive independently has a length and a width that is 80-95% of a length and a width of the battery cell, respectively.

4. The stackable solid-state battery cell of claim 1, wherein the printed adhesive has a thickness of <1 μm.

5. The stackable solid-state battery cell of claim 1, wherein the printed adhesive comprises a thermosetting adhesive.

6. The stackable solid-state battery cell of claim 1, further comprising a conductive bump on the ACC, the conductive bump having a height, and the insulator layer having a thickness smaller than the height of the conductive bump.

7. The stackable solid-state battery cell of claim 1, wherein the substrate comprises a metal foil, film or sheet.

8. The stackable solid-state battery cell of claim 6, wherein the substrate comprises the metal foil, and the metal foil has a thickness of 0.1-100 μm.

9. The stackable solid-state battery cell of claim 6, wherein the substrate further comprises a barrier on one or more major surfaces of the metal foil, film or sheet, and the barrier has a thickness effective to prevent migration of atoms or ions from the metal foil into overlying layers.

10. The stackable solid-state battery cell of claim 1, wherein the cathode comprises a lithium metal oxide or lithium metal phosphate, the solid-state electrolyte comprises a lithium phosphorus oxynitride, Li₂WO₄ or a lithium lanthanum zirconium oxide, and the ACC comprises nickel, zinc, copper, an alloy thereof, or graphite.

11. The stackable solid-state battery cell of claim 1, wherein the insulator layer comprises a polyolefin and/or an inorganic oxide layer.

12. The stackable solid-state battery cell of claim 1, further comprising a moat in the cathode and the solid-state electrolyte, surrounding the ACC and configured to physically separate an active portion of the battery cell from a peripheral region of the battery cell.

13. A packaged solid-state battery, comprising:
a plurality of the stackable solid-state battery cells of claim 1 wherein at least one adhesive layer of the solid-state battery cells is between adjacent ones of the solid-state battery cells;
a first terminal in electrical contact with the conductive redistribution layer on the sidewall portion of the insulator layer; and
a second terminal in electrical contact with an exposed surface of the substrate.

14. A method of making a stackable solid-state battery cell, comprising:
forming an insulator layer on a patterned anode current collector (ACC), wherein the ACC is on a solid-state electrolyte, the solid-state electrolyte is on a cathode, the cathode is on or over a substrate, the insulator layer has an opening enabling electrical contact with the ACC, and a portion of the insulator layer is formed on a sidewall of each of the ACC, the solid-state electrolyte, the cathode and the substrate;
forming a patterned conductive redistribution layer on the insulator layer, including along the sidewall portion of the insulator layer, such that the redistribution layer is in electrical contact with the ACC; and
printing an adhesive on a major surface of the battery cell, wherein the major surface is (i) an outermost surface of the redistribution layer and the insulator layer, or (ii) a surface of the substrate opposite from the cathode.

15. The method of claim 14, wherein the adhesive has a thickness of <1 μm.

16. The method of claim 14, wherein printing the adhesive comprises screen printing, inkjet printing, stencil printing, gravure printing, or flexographic printing the adhesive in a pattern on the major surface of the battery cell, and curing the adhesive by heating the adhesive to a curing temperature and/or irradiating the adhesive with ultraviolet light.

17. The method of claim 16, wherein printing the adhesive comprises screen printing a solution of the adhesive in a solvent on the major surface of the battery cell, and removing the solvent.

18. The method of claim 14, wherein the patterned conductive redistribution layer is selectively deposited on the insulator layer by a process comprising inkjet printing, aerosol-jet printing or screen printing an ink or a paste of a precursor of the conductive redistribution layer, and curing the ink or the paste.

19. The method of claim 14, further comprising blanket-depositing the cathode on or over the substrate, blanket-depositing the solid-state electrolyte on the cathode, and forming the patterned ACC on the solid-state electrolyte.

20. The method of claim 14, further comprising printing a conductive bump on the ACC prior to forming the insulator layer, wherein the opening is in a same location as the conductive bump, and the conductive bump has a height greater than a thickness of the insulator layer.
